(19) United States
(12) Patent Application Publication
(10) Pub. No.: US 2010/0050533 A1
(43) Pub. Date: Mar. 4, 2010

(54) DOUBLE-SIDED INSPECTION SCREEN

(75) Inventors: Oleksandr Stanislavovych Klapishevskyy, Kiev (UA); Anatoliy Mykhaylovych Tsomyk, Kiev (UA)

Correspondence Address: HOUSTON ELISEEVA, 4 MILITIA DRIVE, SUITE 4, LEXINGTON, MA, 02421, US

(73) Assignee: CLOSED JOINT-STOCK COMPANY 'VENTILATION SYSTEMS', Kiev (UA)

(21) Appl. No.: 12/549,536

(22) Filed: Aug. 28, 2009

(30) Foreign Application Priority Data
Aug. 28, 2008 (UA) U 200810711

(51) Int. Cl. E06B 3/36; E04F 19/08

(52) U.S. Cl. 49/400

(57) ABSTRACT

A double-sided inspection screen which can be installed either following the front side installation mode is disclosed, or as a rear side installation model. The screen is arranged so as to provide easy opening of the cover by a slight hand push without recourse to any additional tools. Said arrangement secures quick and easy access to various communications and/or production assemblies and/or devices.

### RELATED APPLICATIONS

This application claims priority to Ukrainian Patent Application No. u 2008 10711, filed on Aug. 28, 2008, which is incorporated herein by reference in its entirety.

### FIELD OF THE INVENTION

This invention relates to the construction domain, namely construction equipment and in particular to installation tools—screens.

### BACKGROUND OF THE INVENTION

It is contemporary practice in building design to envisage a concealed emplacement of various communications and/or production assemblies and/or devices. Such communications and/or production assemblies and/or devices require continuous supervision, maintenance and repair action. This, in turn, entails the development of appropriate engineering solutions which would provide for easy access to such communications and/or production assemblies and/or devices that are built in walls, floors or ceilings of the building.

Most of known inspection screens are manufactured from wood and/or metal. However, this solution has a lot of drawbacks such as dryout or structural deformation of wood. The metal inspection screens are more efficient than those made of wood, and are widely used nowadays. Yet, a considerable weight of the whole construction and a high risk of injuries run while using the metal inspection screens encourage to seek other manufacturing opportunities.

### SUMMARY OF THE INVENTION

This utility model discloses a double-sided inspection screen which can be installed either front side or rear side and is embodied so that its cover opens by a slight hand push without resorting to any additional tools, thanks to which quick and easy access to different communications and/or production assemblies and/or devices is secured.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1: Displayed on the sketch (sectional view) is the front side installation option of the double-sided inspection screen (state of the art, U.S. Pat. No. 4,890,418);

FIG. 2: Displayed on the sketch (sectional view) is the rear side installation option of the double-sided inspection screen (state of the art, U.S. Pat. No. 4,890,418);

FIG. 3: Displayed on the sketch (sectional view) is the clamping of the cover in the frame by means of articulated connection (state of the art, U.S. Pat. No. 4,890,418);

FIG. 4: Displayed is the lower (upper) profile of the double-sided inspection screen frame with arranged orifices;

FIG. 5: Displayed is the cover of the double-sided inspection screen with L-shaped holders;

FIG. 6: Displayed on the sketch (sectional view) is the articulated connection of the screen cover with the frame. The section shaded black is the screen cover and the cross-hatched section is the profile of the screen's frame.

FIG. 7: Displayed on the sketch (sectional view) is the clamping of the screen cover in the frame. The section shaded black is the screen cover and the cross-hatched section is the profile of the screen frame.

FIG. 8: Displayed on the sketch (sectional view) is the confinement of an undesirable range of motion of the screen cover relative to the screen frame for front side installation of the screen (right profile of the screen frame). The section shaded black is the screen cover, and the cross-hatched section is the profile of the screen frame.

FIG. 9: Displayed on the sketch (sectional view) is the confinement of an undesirable range of motion of the screen cover relative to the screen frame for front side installation of the screen (left profile of the screen frame). The section shaded black is the screen cover and the cross-hatched section is the profile of the screen frame.

FIG. 10: Displayed on the sketch is the range of motion of the screen cover in the frame for the front side installation of the screen.

FIG. 11: Displayed on the sketch (sectional view) is the confinement of an undesirable range of motion of the screen cover relative to the screen frame for rear side installation of the screen (right profile of the screen frame). The section shaded black is the screen cover and the cross-hatched section is the profile of the screen frame.

FIG. 12: Displayed on the sketch (sectional view) is the confinement of an undesirable range of motion of the screen cover relative to the screen frame for rear side installation of the screen (left profile of the screen frame). The section shaded black is the screen cover and the cross-hatched section is the profile of the screen frame.

FIG. 13: Displayed on the sketch is the range of motion of the screen cover in the frame for the rear side installation of the screen.

FIG. 14: General view of the screen for the front side installation. A—front view, B—rear view.

FIG. 15: General view of the screen for the rear side installation. A—front view, B—rear view.

### DETAILED DESCRIPTION OF THE PREFERRED EMBODIMENTS

The inspection screens made of plastic have gained broad application since recently. Known from the prior art are many solutions disclosing dimensions, a frame profile as well as the method for fastening the screen cover to the frame.

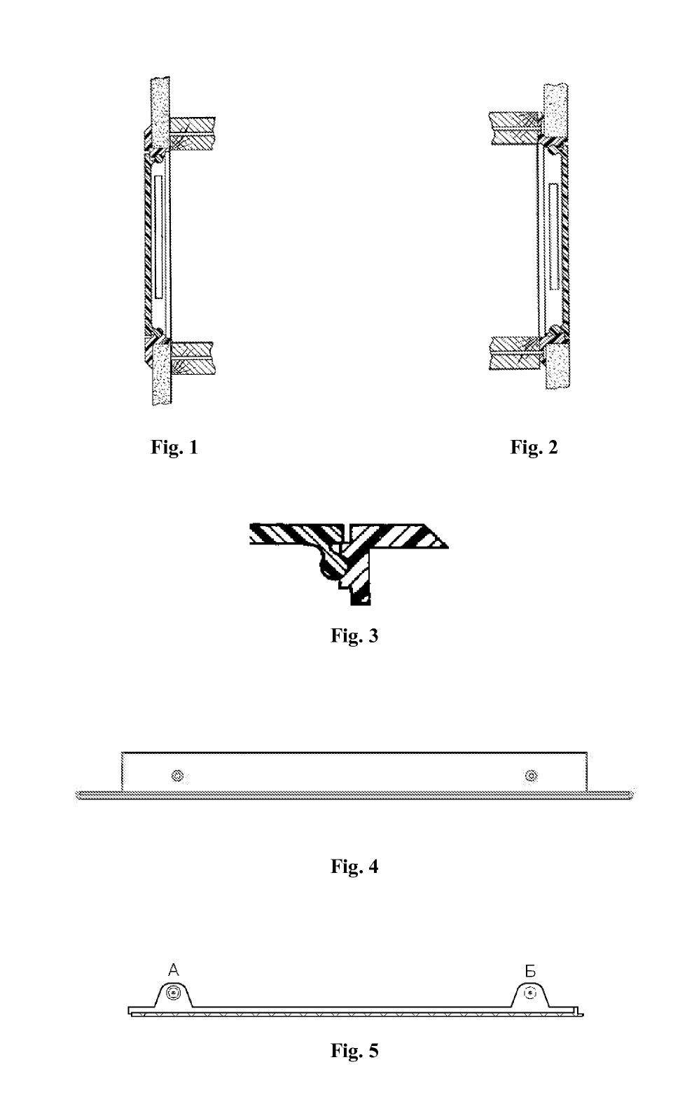

The U.S. Pat. No. 4,890,418, as of Feb. 1, 1990 discloses a solution which is similar to the said utility model. Thus, the said Patent discloses a double-sided inspection screen which can be installed following both the front side and rear side installation options as displayed on FIGS. 1, 2 respectively. Said features extend the scope of application allowing the screen to be installed either with the frame mounted outwards taking advantage of the ornamental feature of the device, or with the frame being arranged inwards for the cases when the concealed emplacement of the inspection screen is implied.

The disadvantage of the said embodiment consists in applying a so-called articulated connection to fasten the cover to the frame as shown on FIG. 3. The said method requires additional tools, such as a blade screwdriver, a hard plate etc. to detach the cover from the frame. A minor amount of recurrent attachment/detachment operations results in mechanical damage both to the cover and/or the frame, an excessive resort to accessories may lead to collapse of separate elements of the articulated connection. Applying additional tools prolongs the cover opening and shutting steps to up to 3-5 min.

An additional disadvantage of such construction consists in that the screen is not provided with a permanent fastening detail for clamping the cover in the frame due to which the former often gets lost during the installation process.

The objective of this utility model is to provide an inspection screen with the cover that could be easily opened/shut without recourse to additional tools, and fixed reliably to reduce time of the opening/shutting step, and hereby enhance the reliability and user-friendliness.

The problem confronted is solved by means of the screen design. The screen comprises a cover, upper, lower, right and left profiles forming the frame. The upper and lower profiles have the orifices which are arranged symmetrically to the edge of the profile and on ½ of the profile width as shown on FIG. 4. The screen cover has L-shaped holders which are arranged symmetrically to the cover edges as shown on FIG. 5, and axially aligned one against another on the upper and lower parts of the cover. The holders are provided with engaging and clamping elements. As shown on FIG. 5, the L-shaped holder A has an engaging element in the form of a cylindrical rod, and the L-shaped holder on FIG. 5 has a clamping element in the form of a spherical lug.

In order to obviate an undesirable range of motion of the screen cover relative to the screen frame, the right profile of the screen frame is provided with a lug (front side) and a groove (rear side). Similarly, the left profile of the screen frame has a groove (front side) and a lug (rear side). The screen cover is arranged in such a way that the groove is located on the side of the engaging holders (A, FIG. 5) whereas the lug is provided on the side of the clamping holders (B, FIG. 5).

It is important to note that the sides on which engaging and clamping elements are arranged, are referred to as upper and lower parts respectively.

Those skilled in the art will understand that in the mirror view the markings “right side” and “left side” are likely to get reversed. In much the same way the marking “upper” can be changed to “lower” and vice versa.

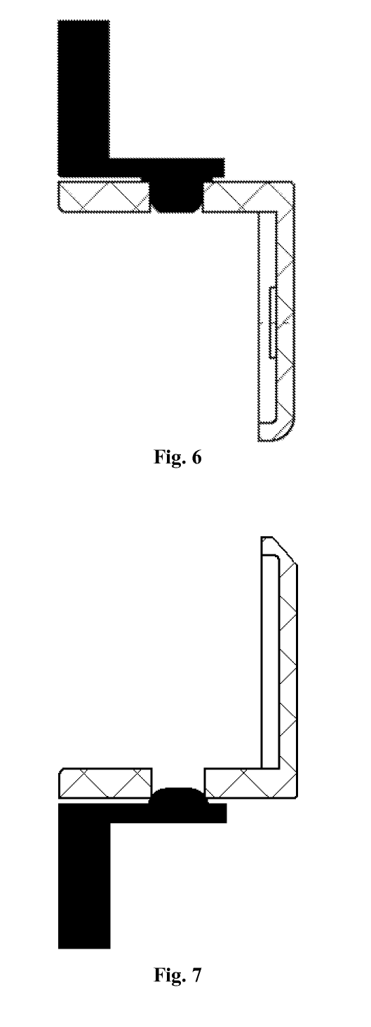

A more detailed explanation of how the screen cover is clamped in the screen frame can be found on the sketch on FIG. 6. Upper and lower L-shaped holders with cylindrical rods (engaging holders) of the screen cover are engaged into the orifices in the upper and lower profiles of the screen frame. The newly obtained engagement allows the cover to be held fixed in the frame and provides revolution around the clamping axis.

An additional embodiment of the said utility model are detachable cylindrical rods on the L-shaped holders implicating that the rods can be installed/dismantled by means of thread, interlock or any other way known from the prior art.

A more detailed explanation of how the screen cover is clamped in the screen frame can be found on the sketch on FIG. 7. The upper and lower L-shaped holders with cylindrical rods (engaging holders) of the screen cover are engaged in the orifices in the upper and lower profiles of the screen frame. Due to the spherical form of the lugs and resilience of the L-shaped holder, the screen cover is clamped in the orifices of the screen frame. A slight effort suffices to disengage the screen cover from the orifices of the screen frame thanks to the spherical form of the lugs and resilience of the L-shaped holder.

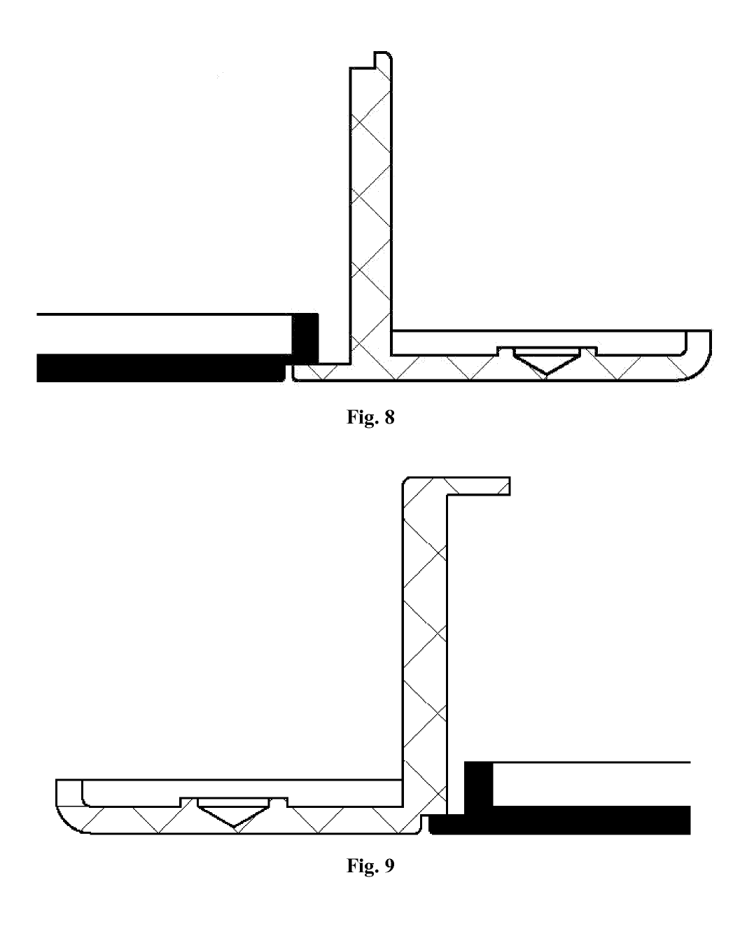

A more detailed description of the confinement of an undesirable range of motion of the screen cover relative to the screen frame is shown on the sketch on FIGS. 8-13.

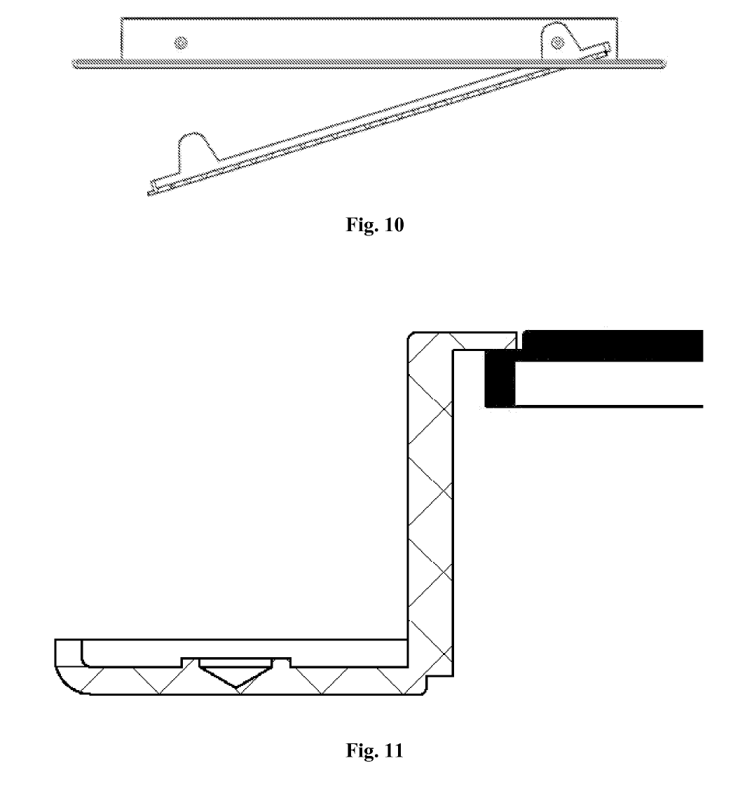

In accordance with the front side installation method the L-shaped engaging holder of the screen cover is engaged into the orifices of the screen frame in such a way that the groove on the screen cover matches the lug on the profile of the screen frame as shown on FIG. 8. Accordingly, when the cover is shut, the lug on the screen cover matches the groove on the profile of the screen frame as shown on FIG. 9. Thus, the confinement provided by the interengagement “lug in frame—groove in cover” and “groove in frame—lug in cover” provides for the movement of the screen cover within the screen frame for the front side installation type as shown on FIG. 10.

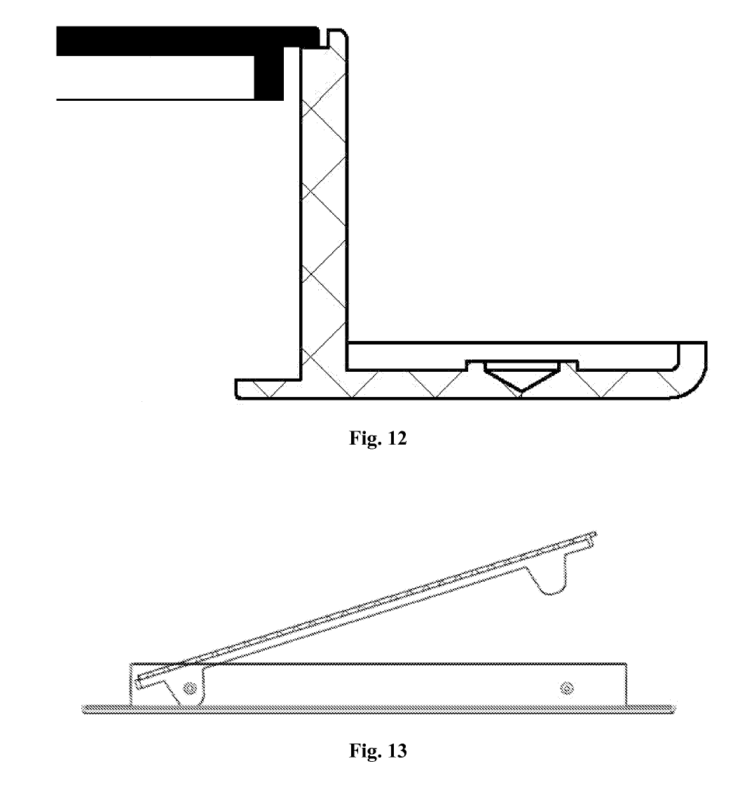

In accordance with the rear side installation method, the L-shaped engaging holder of the screen cover is engaged into the orifices of the screen frame in such a way that the groove on the screen cover matches the lug on the profile of the screen frame as shown on FIG. 11. Accordingly, when the cover is shut, the lug on the screen cover matches the groove on the profile of the screen frame as shown on FIG. 12. Thus, the confinement provided by the interengagement “lug in frame—groove in cover” and “groove in frame—lug in cover” provides for the movement of the screen cover within the screen frame for the rear side installation type as shown on FIG. 13.

An additional embodiment of the utility model is provision of the heterogeneous moiré surface of the cover and/or front side of the screen frame. The said embodiment allows painting directly on the screen cover.

Thus, the screen, as presented hereinbefore, without any limitations, reduces the time of the opening/shutting step of the screen cover, enhancing hereby the reliability and user-friendliness.

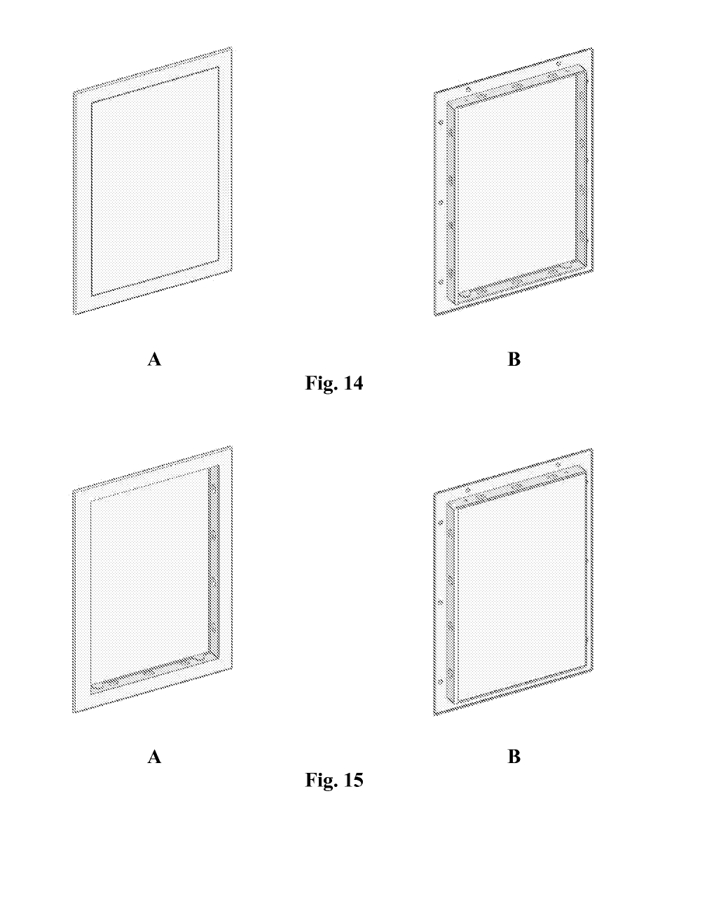

The notion “front side installation” used in this application, signifies the model for installation of the screen cover in the screen frame as shown on FIG. 14.

The notion “rear side installation” used in this application, signifies the model for installation of the screen cover in the screen frame as shown on FIG. 15.

The notion “engagement” used in this application, signifies fastening of one element relative to the other element without the possibility of correlative dislocation when external action occurs.

The notion “clamping” used in this application, signifies fastening of one element relative to the other element with the possibility of correlative dislocation when external action occurs.

The notion “resilience” used in this application, signifies a property which is described by the theory of resilient and plastic strain for material used for the fabrication of the cover with the L-shaped holder.

Unless stated otherwise, the technical and scientific terms used in this application have meanings that can be understood by those skilled in the art. All the patents, applications, published applications and other publications as well as definitions from the databases are included in this application by means of reference. When there is any contradiction or difference between the definitions in this part and definitions which are included or cited in any other patents, applications, published applications and other publications as well as definitions from the databases, only the definitions mentioned in this part shall be deemed valid.

### Examples

1.1) Vertical Screen

Rectangular screen made of ABS plastic, −336 mm high, 236 mm wide. Width of the frame profile is 20 mm. The diameter of openings is 4.4 mm. The offset to openings is 47 mm. The distance between the centers of the L-shaped holders is 150 mm. The grooves on the frame profiles and the screen cover are 1.5 mm. The engaging element is installed into the L-shaped holder by means of thread. The moiré pattern is applied onto the surface of the front side of the frame and the cover.

1.2) Vertical Screen

Rectangular screen made of PS plastic, 197 mm high, 291 mm wide. Width of the frame profile is 20 mm. The diameter of openings is 4.4 mm. The offset to openings is 81 mm. The distance between the centers of the L-shaped holders is 190 mm. The grooves on the frame profiles and screen cover are 5 mm.

1.3) Square Screen

Rectangular screen made of BS plastic, 291 mm high, 291 mm wide. Width of the frame profile is 30 mm. The diameter of openings is 4.4 mm. The offset to openings is 81 mm. The distance between the centers of the L-shaped holders is 190 mm. The grooves on the frame profiles and screen cover are 3 mm. The engaging element is installed into the L-shaped holder by means of interlock. The moiré pattern is applied onto the surface of the front side of the frame and the cover.

Screen Operation

1. The screen cover is installed so as to direct the groove toward the lug on the screen frame on the front side. The screen is installed in the pocket where the production assemblies are located. A slight effort suffices to open the screen cover on the groove side (FIG. 8). Doing same procedure on the lug side (FIG. 9) clamps the cover in place.

2. The screen cover is installed so as to direct the groove toward the lug on the screen frame on the rear side. The screen is installed in the orifice where the production assembly is located in order to obtain one single “area” with the wall. A slight effort suffices to open the screen cover on the groove side (FIG. 11). Doing same procedure on the lug side (FIG. 12) clamps the cover in place.

The description above illustrates the technical essence of the said utility model with the examples provided herein. It should be understood that various changes and modifications may be made the rein without departing from the spirit or scope thereof.

While this invention has been particularly shown and described with references to preferred embodiments thereof, it will be understood by those skilled in the art that various changes in form and details may be made therein without departing from the scope of the invention encompassed by the appended claims.

What is claimed is:

1. A double-sided inspection screen comprising:
a cover comprising L-shaped holders axially aligned on the upper and lower parts, the cover having cover edges, the L-shaped holders being arranged symmetrically to the cover edges and coaxially aligned, the L-shaped holders having engaging elements in the form of a cylindrical lug and clamping elements in the form of a spherical lug;
an upper, a lower, a right and a profiles forming a frame, the upper and lower profiles of the frame having orifices situated symmetrically to edges of the upper and lower profiles and at ½ of a width of the upper and lower profiles;
wherein when the right profile comprises a lug on its front side and a groove on its rear side, then the left profile has a groove on its front side and a lug on its rear side, or when the left profile comprises a lug on its front side and a groove on its rear side, then the right profile comprises a groove on its front side and a lug on its rear side; and
wherein the cover is arranged so as to secure a location of engaging elements on the same side with the groove and a location of the clamping elements on the same side with the lug.

2. The screen as claimed in claim 1, wherein the cylindrical lug is installed in the L-shaped holder by means of thread or interlock.

3. The screen as claimed in claim 1, wherein a surface of the cover or/and a front side of the frame is provided with a moiré pattern.
